(19) United States
(12) Patent Application Publication
(10) Pub. No.: US 2015/0174725 A1
(43) Pub. Date: Jun. 25, 2015

(54) LAMINATED POLISHING PAD AND METHOD FOR MANUFACTURING SAME

(71) Applicant: TOYO TIRE & RUBBER CO., LTD., Osaka-shi, Osaka (JP)

(72) Inventor: Tsuyoshi Kimura, Osaka (JP)

(21) Appl. No.: 14/416,031

(22) PCT Filed: May 20, 2013
(86) PCT No.: PCT/JP2013/063894

§ 371 Date: Jan. 20, 2015

(30) Foreign Application Priority Data
Jul. 24, 2012 (JP) 2012-163652

(51) Int. Cl. B24B 37/22; B32B 38/04; B32B 37/12; B32B 38/00; B24B 37/26; B32B 37/18

(52) U.S. Cl. CPC B24B 37/22; B24B 37/26; B32B 37/18; B32B 37/1207; B32B 38/0004; B32B 38/04; B32B 2037/1215

(57) ABSTRACT

The purpose of the present invention is to provide a method for manufacturing a laminated polishing pad in which a polishing layer and a support layer resist delamination even when heated to high temperature due to long-time polishing, and the support layer is less likely to wrinkle. This method for manufacturing a laminated polishing pad, comprising the steps of: preparing a laminate comprising a polishing layer, a support layer, and a hot-melt adhesive member placed between the polishing layer and the support layer; and allowing the laminate to pass between a pair of lamination rolls so that the polishing layer and the support layer are bonded with the hot-melt adhesive member to form a laminated polishing sheet, wherein in the laminate, the ratio TD1 (TD length of the polishing layer)/TD2 (TD length of the support layer) is constantly adjusted to 0.3 or more.

### TECHNICAL FIELD

The present invention relates to a laminated polishing pad by which the planarizing processing of optical materials such as lenses, reflecting mirrors and the like, silicon wafers, glass substrates for hard disks, aluminum substrates, and materials requiring a high degree of surface planarity such as those in general metal polishing processing can be carried out stably with high polishing efficiency, and a method for manufacturing same. The laminated polishing pad of the present invention is used particularly preferably in a process of planarizing a silicon wafer, and a device having an oxide layer, a metal layer or the like formed on a silicon wafer, before lamination and formation of the oxide layer, the metal layer or the like.

### BACKGROUND ART

Production of a semiconductor device involves a step of forming an electroconductive film on the surface of a wafer to form a wiring layer by photolithography, etching etc., a step of forming an interlaminar insulating film on the wiring layer, etc., and an uneven surface made of an electroconductive material such as metal and an insulating material is generated on the surface of a wafer by these steps. In recent years, processing for fine wiring and multilayer wiring is advancing for the purpose of higher integration of semiconductor integrated circuits, and accordingly techniques of planarizing an uneven surface of a wafer have become important.

As the method of planarizing an uneven surface of a wafer, a CMP method is generally used. CMP is a technique wherein while the surface of a wafer to be polished is pressed against a polishing surface of a polishing pad, the surface of the wafer is polished with slurry having abrasive grains dispersed therein. As shown in FIG. 1, a polishing apparatus used generally in CMP is provided for example with a polishing platen 2 for supporting a polishing pad 1, a supporting stand (polishing head) 5 for supporting a polished material (wafer) 4, a backing material for uniformly pressurizing a wafer, and a mechanism of feeding an abrasive. The polishing pad 1 is fitted with the polishing platen 2 for example via a double-sided tape. The polishing platen 2 and the supporting stand 5 are provided with rotating shafts 6 and 7 respectively and are arranged such that the polishing pad 1 and the polished material 4, both of which are supported by them, are opposed to each other. The supporting stand 5 is provided with a pressurizing mechanism for pushing the polished material 4 against the polishing pad 1.

Conventional polishing pads for use in high-precision polishing are generally produced using a polyurethane resin foam sheet. Unfortunately, such a polyurethane resin foam sheet has insufficient cushioning properties and therefore can hardly apply uniform pressure to the entire surface of a wafer, though it has high local-planarization performance. In general, therefore, a soft cushion layer is additionally provided on the back side of such a polyurethane resin foam sheet, and the resulting laminated polishing pad is used for polishing.

However, conventional laminated polishing pads, which usually have a polishing layer and a cushion layer bonded together with a double-sided tape, have a problem in that a slurry can enter between the polishing layer and the cushion layer during polishing, so that the durability of the double-sided tape can decrease and delamination can easily occur between the polishing layer and the cushion layer.

Examples of proposed methods to solve this problem include the techniques described below.

Patent Document 1 discloses that a plastic film and a polishing pad are bonded together with a reactive hot-melt adhesive.

Patent Document 2 discloses a polishing pad including a base layer and a polishing layer bonded together with a hot-melt adhesive layer.

Patent Document 3 discloses a method for manufacturing a multilayer polishing pad, the method including: providing a double-sided pressure-sensitive adhesive tape including a backing, a hot-melt adhesive layer formed on one side of the backing, and a pressure-sensitive adhesive layer formed on the other side of the backing; placing a hard pad body on one side of the backing with the hot-melt adhesive layer interposed therebetween, while heating the hot-melt adhesive layer; and then pressing a cushioning subpad against the pressure-sensitive adhesive layer so that the cushioning subpad is placed on the other side of the backing with the pressure-sensitive adhesive layer interposed therebetween.

Patent Document 4 discloses a technique for forming a polishing pad including a polishing layer and a base layer bonded together with a double-sided tape, wherein a water blocking layer including a hot-melt adhesive is provided between the back side of the polishing layer and the double-sided tape to block a polishing slurry.

Patent Document 5 discloses a polishing pad including a polishing layer and a lower layer, which are bonded together with a hot-melt adhesive containing EVA.

Patent Document 6 discloses a method for manufacturing a multilayer chemical mechanical polishing pad, the method comprising:

providing a polishing layer;

providing a subpad layer having a top surface and a bottom surface;

providing an unset reactive hot-melt adhesive;

applying the unset reactive hot-melt adhesive to the top surface of the subpad layer, wherein the unset reactive hot-melt adhesive is applied in a pattern of parallel lines;

placing a polishing layer over the pattern of parallel lines of unset reactive hot-melt adhesive forming a polishing pad stack;

applying a force to the polishing pad stack so as to press the polishing layer and subpad layer together; and

allowing the unset reactive hot-melt adhesive to be set while forming a reactive hot-melt adhesive bond between the polishing layer and the subpad layer.

When a hot-melt adhesive is used, interlayer delamination can be prevented. However, there is a problem in that when a polishing layer and a cushion layer are bonded with a hot-melt adhesive on a continuous production line using lamination rolls, the cushion layer can easily wrinkle.

### PRIOR ART DOCUMENTS

### Patent Documents

Patent Document 1: JP-A-2002-224944

Patent Document 2: JP-A-2005-167200

Patent Document 3: JP-A-2006-265410

Patent Document 4: JP-A-2009-95945

Patent Document 5: JP-A-2010-525956

Patent Document 6: JP-A-2010-28113

### SUMMARY OF THE INVENTION

### Problems to be Solved by the Invention

It is an object of the invention to provide a method for manufacturing a laminated polishing pad in which a polishing layer and a support layer resist delamination even when heated to high temperature due to long-time polishing, and the support layer is less likely to wrinkle.

### Means for Solving the Problems

The present inventors have intensively studied so as to solve the above problems and as a result, have found that the objects can be achieved by the below-mentioned method for manufacturing a laminated polishing pad, thereby leading to complete the present invention.

That is, the present invention relates to a method for manufacturing a laminated polishing pad, comprising the steps of: preparing a laminate comprising a polishing layer, a support layer, and a hot-melt adhesive member placed between the polishing layer and the support layer; and allowing the laminate to pass between a pair of lamination rolls so that the polishing layer and the support layer are bonded with the hot-melt adhesive member to form a laminated polishing sheet, wherein

in the laminate, the ratio TD1/TD2 is constantly adjusted to 0.3 or more, wherein TD1 is the transverse direction (TD) length of the polishing layer, and TD2 is the transverse direction (TD) length of the support layer.

A conventional process of bonding a polishing layer and a support layer (such as a cushion layer) with a hot-melt adhesive on a continuous production line using lamination rolls include, as shown in FIG. 2, providing a molten hot-melt adhesive (not shown) on a support layer 8, then placing a circular polishing layer 9 on the hot-melt adhesive, and allowing the resulting laminate to pass between a pair of lamination rolls 10 to bond the polishing layer 9 and the support layer 8 with the hot-melt adhesive.

In this conventional process, when the laminate is conveyed to the lamination rolls 10, the linear pressure is applied only to a part of the support layer (shaded part in FIG. 2) on which the polishing layer 9 is placed, and not applied to the other part of the support layer on which the polishing layer 9 is not placed. When the molten hot-melt adhesive is provided on the support layer 8, the support layer 8 becomes soft and easily deformable. On the continuous production line, the support layer 8 is pulled in the feed direction. The linear pressure-receiving part of the support layer 8 (the shaded part in FIG. 2) has a tensile strength higher than that of the part to which no linear pressure is applied. Therefore, a slight difference occurs between the traveling speeds of the linear pressure-receiving part and the part not receiving the linear pressure. This is thought to make the support layer 8 more likely to wrinkle after the bonding.

The inventor has found that, as shown in FIGS. 3 and 4, when the ratio TD1/TD2 is constantly adjusted to 0.3 or more, wherein TD1 is the transverse direction (TD) length of a polishing layer 9, and TD2 is the transverse direction (TD) length of a support layer 8, and when a linear pressure is uniformly applied to a part of the support layer on which the polishing layer 9 is placed (the shaded part in each of FIGS. 3 and 4), the support layer 8 is less likely to wrinkle after the bonding. As shown in FIG. 2, if a circular polishing layer 9 is used or if TD1/TD2 is less than 0.3, it will be difficult to prevent wrinkling.

The method of the invention for manufacturing a laminated polishing pad may include the step of cutting the laminated polishing sheet into a circular shape. When a circular laminated polishing pad is manufactured, the preparation of the laminated polishing sheet should be followed by cutting it into a circular shape.

The method of the invention for manufacturing a laminated polishing pad may include the step of grooving the surface of the laminated polishing sheet. When a laminated polishing pad having a grooved polishing surface is manufactured, the preparation of the laminated polishing sheet is preferably followed by grooving the surface of the polishing layer. If a polishing layer grooved in advance is used in the preparation of the laminated polishing sheet, a difference in linear pressure can occur between the grooved part and the non-grooved part during the lamination, so that the support layer can be more likely to wrinkle after the bonding. In addition, it becomes less easy to apply the pressure to the grooved part, so that insufficient adhesion may occur at the grooved part and air may be easily trapped.

The hot-melt adhesive member is preferably an adhesive layer including a polyester-based hot-melt adhesive or a double-sided adhesive tape including a backing and adhesive layers provided on both sides of the baking and each including a polyester-based hot-melt adhesive. The polyester-based hot-melt adhesive preferably includes 100 parts by weight of a polyester resin as a base polymer and 2 to 10 parts by weight of an epoxy resin having two or more glycidyl groups per molecule.

When 2 to 10 parts by weight of the epoxy resin having two or more glycidyl groups per molecular is added to 100 parts by weight of the polyester resin as a base polymer, the polyester resin can be crosslinked. In this case, the adhesive member can have improved durability against “shearing,” which occurs during polishing, even when high temperature is reached due to long-time polishing, so that the resulting laminated polishing pad can resist delamination between its polishing layer and its support layer.

If the epoxy resin is added in an amount of less than 2 parts by weight, the adhesive member can have insufficient durability against “shearing,” which occurs during polishing, when high temperature is reached due to long-time polishing, so that delamination between the polishing layer and the support layer can be more likely to occur. On the other hand, if the epoxy resin is added in an amount of more than 10 parts by weight, the adhesive layer can have too high hardness and lower tackiness, so that delamination between the polishing layer and the support layer can be more likely to occur.

The polyester resin as a base polymer is preferably a crystalline polyester resin. Using the crystalline polyester resin improves the chemical resistance to slurry, so that the adhesive layer can hardly decrease in adhering strength.

The invention is also directed to a laminated polishing pad obtained by the above manufacturing method, and to a method for producing a semiconductor device, including the step of polishing the surface of a semiconductor wafer with the laminated polishing pad.

### Effect of the Invention

The manufacturing method of the invention makes it possible to manufacture a laminated polishing pad with no wrinkles in its support layer even when the support layer and the polishing layer are bonded with a hot-melt adhesive member on a continuous production line using lamination rolls. In the laminated polishing pad according to the invention, the polishing layer and the support layer are laminated with an adhesive member including a specific polyester-based hot-melt adhesive interposed therebetween. Therefore, delamination is less likely to occur between the polishing layer and the support layer even at a high temperature due to long-time polishing.

### BRIEF DESCRIPTION OF THE DRAWINGS

FIG. 1 is a schematic diagram showing an example of a polishing apparatus for use in CMP polishing.

FIG. 2 is a schematic process drawing showing an example of the conventional method for manufacturing a laminated polishing pad.

FIG. 3 is a schematic process drawing showing an example of the method of the invention for manufacturing a laminated polishing pad.

FIG. 4 is a schematic process drawing showing an example of the method of the invention for manufacturing a laminated polishing pad.

### MODE FOR CARRYING OUT THE INVENTION

The method of the invention for manufacturing a laminated polishing pad includes the steps of: preparing a laminate including a polishing layer, a support layer, and a hot-melt adhesive member placed between the polishing layer and the support layer; and allowing the laminate to pass between a pair of lamination rolls so that the polishing layer and the support layer are bonded with the hot-melt adhesive member to form a laminated polishing sheet.

The polishing layer is not restricted as long as it is a foam containing fine cells. For example, the material for the foam may be one of or a blend of two or more of polyurethane resin, polyester resin, polyamide resin, acrylic resin, polycarbonate resin, halogen-containing resin (such as polyvinyl chloride, polytetrafluoroethylene and polyvinylidene fluoride etc.), polystyrene, olefin resin (such as polyethylene and polypropylene etc.), epoxy resin, and photosensitive resin. Polyurethane resin is particularly preferred as a material for forming the polishing layer because polyurethane resin has good wear resistance and because urethane polymers having desired physical properties can be easily obtained through changing the composition of raw materials in various manners. Hereinafter, polyurethane resin will be described as a typical example of the material for the foam.

The polyurethane resin contains an isocyanate component, a polyol component (high-molecular-weight polyol, low-molecular-weight polyol etc.) and a chain extender.

As the isocyanate component, a compound known in the field of polyurethane can be used without particular limitation. The isocyanate component includes, for example, aromatic diisocyanates such as 2,4-toluene diisocyanate, 2,6-toluene diisocyanate, 2,2′-diphenyl methane diisocyanate, 2,4′-diphenyl methane diisocyanate, 4,4′-diphenyl methane diisocyanate, 1,5-naphthalene diisocyanate, p-phenylene diisocyanate, m-phenylene diisocyanate, p-xylylene diisocyanate and m-xylylene diisocyanate, aliphatic diisocyanates such as ethylene diisocyanate, 2,2,4-trimethyl hexamethylene diisocyanate and 1,6-hexamethylene diisocyanate, and cycloaliphatic diisocyanates such as 1,4-cyclohexane diisocyanate, 4,4′-dicyclohexyl methane diisocyanate, isophorone diisocyanate and norbornane diisocyanate. These may be used alone or as a mixture of two or more thereof.

As the high-molecular-weight polyol, a compound known in the field of polyurethane can be used without particular limitation. The high-molecular-weight polyol includes, for example, polyether polyols represented by polytetramethylene ether glycol and polyethylene glycol, polyester polyols represented by polybutylene adipate, polyester polycarbonate polyols exemplified by reaction products of polyester glycols such as polycaprolactone polyol and polycaprolactone with alkylene carbonate, polyester polycarbonate polyols obtained by reacting ethylene carbonate with a multivalent alcohol and reacting the resulting reaction mixture with an organic dicarboxylic acid, and polycarbonate polyols obtained by ester exchange reaction of a polyhydroxyl compound with aryl carbonate. These may be used singly or as a mixture of two or more thereof.

Besides the above high-molecular-weight polyol described in the above as a polyol component, it is preferred to concomitantly use a low-molecular-weight polyol such as ethyleneglycol, 1,2-propylene glycol, 1,3-propylene glycol, 1,2-butanediol, 1,3-butanediol, 1,4-butanediol, 2,3-butanediol, 1,6-hexanediol, neopentylglyol, 1,4-cyclohexanedimethanol, 3-methyl-1,5-pentanediol, diethyleneglycol, triethyleneglycol, 1,4-bis(2-hydroxyethoxy)benzene, trimethylolpropane, glycerin, 1,2,6-hexanetriol, pentaerythritol, tetramethylol cyclohexane, methylglucoside, sorbitol, mannitol, dulcitol, sucrose, 2,2,6,6-tetrakis(hydroxymethyl)cyclohexanol, diethanolamine, N-methyldiethanolamine and triethanol amine. Low-molecular-weight polyamine such as ethylenediamine, tolylenediamine, diphenylmethanediamine, and diethylenetriamine may be used. Alcohol amine such as monoethanol amine, 2-(2-aminoethylamino) ethanol and monopropanol amine may be used. These may be used singly or in combination of two or more kinds. The content of the low-molecular-weight polyol, the low-molecular-weight polyamine, or other materials is not particularly limited, and may be appropriately determined depending on the properties required of the polishing pad (polishing layer) to be manufactured.

In the case where a polyurethane resin foam is produced by means of a prepolymer method, a chain extender is used in curing of a prepolymer. A chain extender is an organic compound having at least two active hydrogen groups and examples of the active hydrogen group include: a hydroxyl group, a primary or secondary amino group, a thiol group (SH) and the like. Concrete examples of the chain extender include: polyamines such as 4,4′-methylenebis(o-chloroaniline) (MOCA), 2,6-dichloro-p-phenylenediamine, 4,4′-methylenebis(2,3-dichloroaniline), 3,5-bis(methylthio)-2,4-toluenediamine, 3,5-bis(methylthio)-2,6-toluenediamine, 3,5-diethyltoluene-2,4-diamine, 3,5-diethyltoluene-2,6-diamine, trimethylene glycol-di-p-aminobenzoate, polytetramethylene oxide-di-p-aminobenzoate, 4,4′-diamino-3,3′,5,5′-tetraethyldiphenylmethane, 4,4′-diamino-3,3′-diisopropyl-5.5′-dimethyldiphenylmethane, 4,4′-diamino-3,3′,5,5′-tetraisopropyldiphenylmethane, 1,2-bis(2-aminophenylthio)ethane, 4,4′-diamino-3,3′-diethyl-5.5′-dimethyldiphenylmethane, N,N′-di-sec-butyl-4,4′-diaminophenylmethane, 3,3′-diethyl-4,4′-diaminodiphenylmethane, m-xylylenediamine, N,N′-di-sec-butyl-p-phenylenediamine, m-phenylenediamine and p-xylylenediamine; the low-molecular-weight polyol; and the low-molecular-weight polyamine. The chain extenders described above may be used either alone or in mixture of two kinds or more.

A polyurethane resin foam can be produced by applying a melting method, a solution method or a known polymerization technique, among which preferable is a melting method, consideration being given to a cost, a working environment and the like.

Manufacture of a polyurethane resin foam is enabled by means of either a prepolymer method or a one shot method, of which preferable is a prepolymer method in which an isocyanate-terminated prepolymer is synthesized from an isocyanate component and a polyol component in advance, with which a chain extender is reacted since physical properties of an obtained polyurethane resin is excellent.

Manufacturing methods of a polyurethane resin foam include: a method in which hollow beads are added, a mechanical foaming method, a chemical foaming method and the like.

Particularly, preferred is a mechanical foaming method using a silicone-based surfactant which is a copolymer of polyalkylsiloxane and polyether and has no an active hydrogen group.

A stabilizer such as antioxidant, a lubricant, a pigment, a filler, an antistatic agent and other additives may be added, as needed.

The polyurethane resin foam may be of a closed cell type or an open cell type.

An average cell diameter of a polyurethane resin foam is preferably in the range of from 30 to 80 μm and more preferably in the range of from 30 to 60 If an average cell diameter falls outside the range, a tendency arises that a polishing rate is decreased and a planarity of an object to be polished (a wafer) after polishing is reduced.

Preferably, the polyurethane resin foam has a specific gravity ranging from 0.5 to 1.3. When the specific gravity is less than 0.5, the surface strength of the polishing layer decreases, so that the planarity of the object to be polished tends to decrease. When the specific gravity is larger than 1.3, the cell number on the surface of the polishing layer decreases, so that the polishing rate tends to decrease despite excellent planarity.

Preferably, the polyurethane resin foam has a hardness measured by ASKER D hardness meter, ranging from 40 to 75 degrees. When the ASKER D hardness is less than 40 degrees, the planarity of the object to be polished decreases, while when the hardness is more than 75 degrees, the uniformity of the object to be polished tends to decrease despite excellent planarity.

The thickness of the polishing layer is generally, but is not limited to, about 0.8 to 4 mm, and preferably 1.2 to 2.5 mm.

The support layer is provided to supplement the characteristics of the polishing layer. The support layer to be used may be a layer (cushion layer) having an elastic modulus lower than that of the polishing layer or may be a layer (high modulus layer) having an elastic modulus higher than that of the polishing layer. The cushion layer is necessary for CMP to achieve both good planarity and good uniformity, which are usually in a trade-off relationship. The term “planarity” refers to the flatness of a patterned part formed by polishing an object to be polished having fine irregularities, which are produced in a patterning process. The term “uniformity” refers to the entire uniformity of an object to be polished. The characteristics of the polishing layer contribute to an improvement in planarity, and the characteristics of the cushion layer contribute to an improvement in uniformity. The high modulus layer is used to improve the planarizing characteristics of the polishing pad when a relatively soft polishing layer is used in order to suppress scratching in CMP. The use of the high modulus layer makes it possible to suppress excessive polishing of the edge of an object to be polished.

Examples of the cushion layer include nonwoven fiber fabrics such as polyester nonwoven fabrics, nylon nonwoven fabrics, and acrylic nonwoven fabrics; resin impregnated nonwoven fabrics such as polyurethane impregnated polyester nonwoven fabrics; polymeric resin foams such as polyurethane foams and polyethylene foams; rubber resins such butadiene rubber and isoprene rubber; and photosensitive resins, etc.

The thickness of the cushion layer is preferably, but not limited to, 300 to 1,800 μm, more preferably 700 to 1,400 μm.

Examples of the high modulus layer include a metal sheet, a resin film, and the like. Examples of the resin film, include polyester films such as polyethylene terephthalate films and polyethylene naphthalate films; polyolefin films such as polyethylene films and polypropylene films; nylon films; and polyimide films, etc.

The thickness of the high modulus film is preferably, but not limited to, 10 to 200 μm, more preferably 15 to 55 μm, in view of stiffness, dimensional stability during heating, and other properties.

The laminate is prepared by laminating the polishing layer and the support layer with the hot-melt adhesive member interposed therebetween.

An adhesive layer including a common hot-melt adhesive may be used as the hot-melt adhesive member. In particular, an adhesive layer including a polyester-based hot-melt adhesive is preferably used.

The polyester-based hot-melt adhesive contains at least a polyester resin as a base polymer and an epoxy resin having two or more glycidyl groups per molecule, in which the epoxy resin is a crosslinking component.

The polyester resin may be any known polyester resin which is obtained by condensation polymerization of an acid and a polyol or other polymerization processes. In particular, the polyester resin is preferably a crystalline polyester resin.

Examples of the acid include aromatic dicarboxylic acids, aliphatic dicarboxylic acids, and alicyclic dicarboxylic acids, etc. These may be used alone or in combination of two or more.

Examples of aromatic dicarboxylic acids include terephthalic acid, isophthalic acid, phthalic anhydride, α-naphthalene dicarboxylic acid, β-naphthalene dicarboxylic acid, and their ester forms, etc.

Examples of aliphatic dicarboxylic acids include succinic acid, glutaric acid, adipic acid, pimelic acid, suberic acid, azelaic acid, sebacic acid, undecylenic acid, dodecanedioic acid, and their ester forms, etc.

Examples of alicyclic dicarboxylic acids include 1,4-cyclohexane dicarboxylic acid, tetrahydrophthalic anhydride, hexahydrophthalic anhydride, etc.

An unsaturated acid such as maleic acid, fumaric acid, or dimer acid, a polycarboxylic acid such as trimellitic acid or pyromellitic acid, or other acids may also be used as the acid in combination with any of the above acids.

Examples of the polyol include dihydric alcohols such as aliphatic glycols and alicyclic glycols, and polyhydric alcohols. These may be used alone or in combination of two or more.

Examples of aliphatic glycols include ethylene glycol, 1,2-propylene glycol, 1,3-propylene glycol, 1,3-butanediol, 1,4-butanediol, 1,5-pentanediol, 1,6-hexanediol, 1,8-octanediol, 1,9-nonanediol, neopentyl glycol, 3-methylpentanediol, 2,2,3-trimethylpentanediol, diethylene glycol, triethylene glycol, dipropylene glycol, etc.

Examples of alicyclic glycols include 1,4-cyclohexanedimethanol, hydrogenated bisphenol A, etc.

Examples of polyhydric alcohols include glycerin, trimethylolethane, trimethylolpropane, pentaerythritol, etc.

The crystalline polyester resin can be synthesized by known methods. Examples include melt polymerization methods including adding raw materials and a catalyst and heating the mixture at a temperature equal to or higher than the melting point of the desired product, solid-phase polymerization methods including performing polymerization at a temperature equal to or lower than the melting point of the desired product, and solution polymerization methods using a solvent, etc. Any of these methods may be used.

The crystalline polyester resin preferably has a melting point of 100 to 200° C. If the melting point is lower than 100° C., the adhesive strength of the hot-melt adhesive can be lowered by heat generated during polishing. If the melting point is higher than 200° C., a higher temperature will be needed to melt the hot-melt adhesive, which may warp the laminated polishing pad and tend to have an adverse effect on the polishing characteristics.

The crystalline polyester resin preferably has a number average molecular weight of 5,000 to 50,000. If the number average molecular weight is less than 5,000, the hot-melt adhesive may have lower mechanical characteristics, so that a sufficient level of tackiness and durability may fail to be obtained. If the number average molecular weight is more than 50,000, a production failure such as gelation may occur in the process of synthesizing the crystalline polyester resin, or the hot-melt adhesive may tend to have lower performance.

Examples of the epoxy resin include aromatic epoxy resins such as bisphenol A type epoxy resins, brominated bisphenol A type epoxy resins, bisphenol F type epoxy resins, bisphenol AD type epoxy resins, stilbene type epoxy resins, biphenyl type epoxy resins, bisphenol A novolac type epoxy resins, cresol novolac type epoxy resins, diaminodiphenylmethane type epoxy resins, and polyphenyl-based epoxy resins such as tetrakis(hydroxyphenyl)ethane-based epoxy resins, fluorene-containing epoxy resins, and epoxy resins containing a triglycidyl isocyanurate moiety or a heteroaromatic ring (such as a triazine ring); and non-aromatic epoxy resins such as aliphatic glycidyl ether type epoxy resins, aliphatic glycidyl ester type epoxy resins, alicyclic glycidyl ether type epoxy resins, and alicyclic glycidyl ester type epoxy resins. These may be used alone or in combination of two or more.

Among them, cresol novolac type epoxy resins are preferably used in view of tackiness to the polishing layer during polishing.

The epoxy resin is necessarily added in an amount of 2 to 10 parts by weight, preferably in an amount of 3 to 7 parts by weight, to 100 parts by weight of the polyester resin as a base polymer.

The polyester-based hot-melt adhesive may also contain known additives such as a softener such as an olefin resin, a tackifier, a filler, a stabilizer, and a coupling agent. The adhesive may also contain a known inorganic filler such as talc and other materials.

The polyester-based hot-melt adhesive can be prepared by mixing at least the polyester resin and the epoxy resin and optional materials by any method. For example, the polyester-based hot-melt adhesive can be prepared by mixing the respective raw materials using an extruder such as a mono-screw extruder, a co-rotating intermeshing parallel twin screw extruder, a counter-rotating intermeshing parallel twin screw extruder, a counter-rotating intermeshing inclined twin screw extruder, a non-intermeshing twin screw extruder, an incompletely intermeshing twin screw extruder, a co-kneader extruder, a planetary gear extruder, a transfer mixing extruder, a ram extruder, or a roller extruder, or a kneader, etc.

The polyester-based hot-melt adhesive preferably has a melting point of 100 to 200° C.

The polyester-based hot-melt adhesive preferably has a specific gravity of 1.1 to 1.3.

The polyester-based hot-melt adhesive preferably has a melt flow index of 16 to 26 g/10 minutes under the conditions of 150° C. and a load of 2.16 kg.

The adhesive layer preferably has a thickness of 10 to 200 μm, more preferably 25 to 125 μm.

Examples of the method for laminating the polishing layer and the support layer with the hot-melt adhesive member interposed therebetween include, but are not limited to, (1) a method including: placing an adhesive layer including a hot-melt adhesive on the support layer in the form of a web while conveying the support layer; heating the adhesive layer with a heater to melt the adhesive layer; and then placing the polishing layer on the molten adhesive layer and (2) a method including: applying a molten hot-melt adhesive onto the support layer in the form of a web while conveying the support layer; and then placing the polishing layer on the molten adhesive layer. The polishing layer used to form the laminate may be in the form of a web or an individual piece. When the polishing layer is used in the form of a web, the support layer can be more reliably prevented from wrinkling.

In the step of preparing the laminate, it is necessary to constantly adjust the ratio TD1/TD2 to 0.3 or more, wherein TD1 is the transverse direction (TD) length of the polishing layer, and TD2 is the transverse direction (TD) length of the support layer. TD1/TD2 is preferably from 0.3 to 1.2, more preferably from 0.8 to 1. A TD1/TD2 ratio of more than 1.2 may be disadvantageous in terms of manufacturing cost or may easily cause air to be trapped in the laminate.

A double-sided adhesive tape including a backing and the adhesive layers provided on both sides of the backing may also be used instead of the adhesive layer. The backing can prevent a slurry from permeating to the support layer side, so that delamination between the support layer and the adhesive member can be prevented.

The backing may be a resin film or the like. Examples of the resin film include polyester films such as polyethylene terephthalate films and polyethylene naphthalate films; polyolefin films such as polyethylene films and polypropylene films; nylon films; and polyimide films, etc. Among them, polyester films are preferably used, which have high ability to prevent water permeation.

The surface of the backing may be subjected to an adhesion-facilitating treatment such as a corona treatment or a plasma treatment.

The thickness of the backing is preferably, but not limited to, 10 to 200 μm, more preferably 15 to 55 μm, in view of transparency, flexibility, stiffness, dimensional stability during heating, and other properties.

When the double-sided adhesive tape is used, the thickness of the adhesive layer is preferably from 10 to 200 μm, more preferably from 30 to 100 μm.

Subsequently, the laminate is allowed to pass between a pair of lamination rolls so that the polishing layer and the support layer are bonded with the hot-melt adhesive member to form a laminated polishing sheet. In the step of allowing the laminate to pass between a pair of lamination rolls, the laminate is preferably conveyed in such a way that the front end of the polishing layer is parallel to the rotating shafts of the lamination rolls. A linear pressure should be uniformly applied to a part of the support layer on which the polishing layer is placed, so that the support layer will be less likely to wrinkle after the bonding.

When circular laminated polishing pads are manufactured, the preparation of the laminated polishing sheet is followed by cutting it into circular pieces.

When a laminated polishing pad having a groove for retaining and replacing a slurry on the polishing surface is manufactured, the polishing surface is preferably grooved after the laminated polishing sheet is prepared. The groove is not particularly limited insofar as it is able to retain and refresh a slurry, and for example, XY grating groove, concentric ring groove, through-hole, non-through-hole, polygonal column, circular cylinder, spiral groove, eccentric ring groove, radial groove, and combination thereof can be recited. These grooves generally have regularity, however, groove pitch, groove width, groove depth and the like may be varied by a certain range for achieving desired retention and refreshment of slurry.

The laminated polishing pad of the invention may have a double-sided adhesive tape provided on its surface to be bonded to a platen (polishing platen).

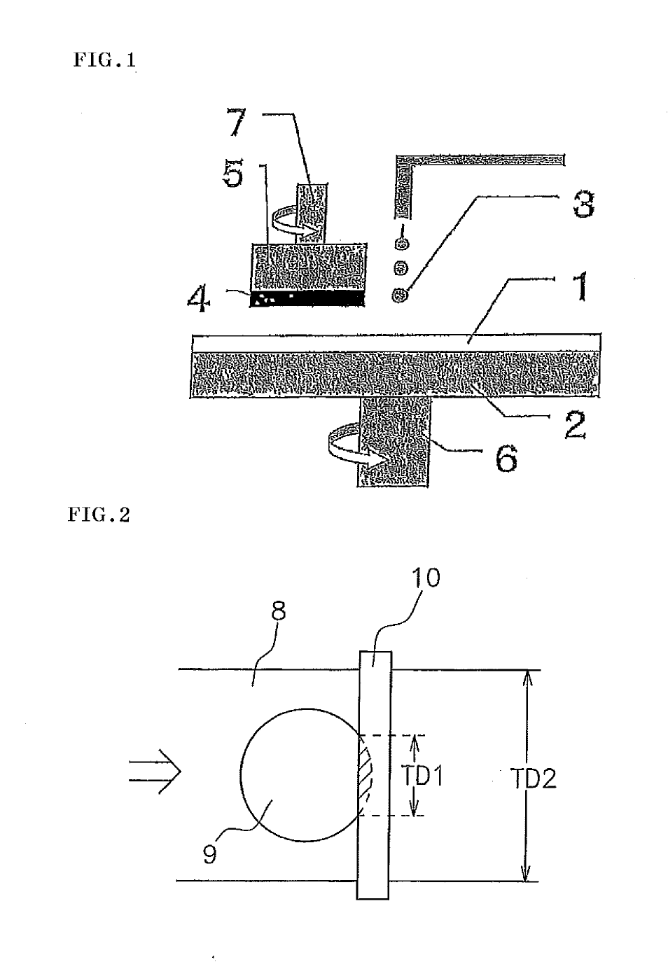

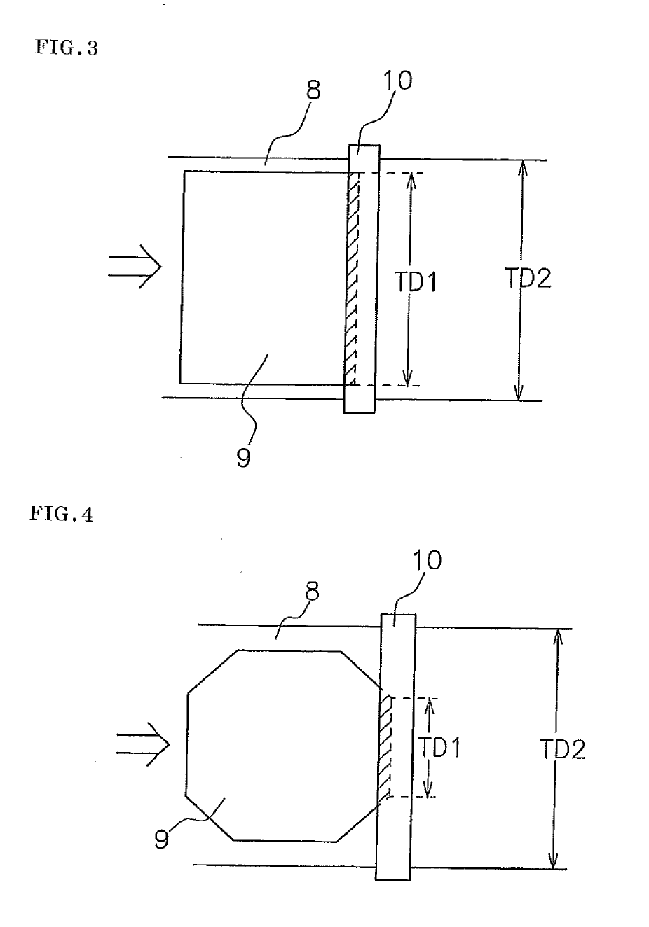

A semiconductor device is fabricated after operation in a step of polishing a surface of a semiconductor wafer with a laminated polishing pad. The term, a semiconductor wafer, generally means a silicon wafer on which a wiring metal and an oxide layer are stacked. No specific limitation is imposed on a polishing method of a semiconductor wafer or a polishing apparatus, and polishing is performed with a polishing apparatus equipped, as shown in FIG. 1, with a polishing platen 2 supporting a laminated polishing pad 1, a polishing head 5 holding a semiconductor wafer 4, a backing material for applying a uniform pressure against the wafer and a supply mechanism of a polishing agent 3. The laminated polishing pad 1 is mounted on the polishing platen 2 by adhering the pad to the platen with a double-sided adhesive tape. The polishing platen 2 and the polishing head 5 are disposed so that the laminated polishing pad 1 and the semiconductor wafer 4 supported or held by them oppositely face each other and provided with respective rotary shafts 6 and 7. A pressure mechanism for pressing the semiconductor wafer 4 to the laminated polishing pad 1 is installed on the polishing head 5 side. During polishing, the semiconductor wafer 4 is polished by being pressed against the laminated polishing pad 1 while the polishing platen 2 and the polishing head 5 are rotated and a slurry is fed. No specific limitation is placed on a flow rate of the slurry, a polishing load, a polishing platen rotation number and a wafer rotation number, which are properly adjusted.

Protrusions on the surface of the semiconductor wafer 4 are thereby removed and polished flatly. Thereafter, a semiconductor device is produced therefrom through dicing, bonding, packaging etc. The semiconductor device is used in an arithmetic processor, a memory etc.

### EXAMPLES

Description will be given of the invention with examples, while the invention is not limited to description in the examples.

[Methods for Measurement and Evaluation]

(Measurement of Melting Point)

The melting point of the polyester-based hot-melt adhesive was measured at a rate of temperature rise of 20° C./minute using TOLEDO DSC822 (manufactured by Mettler-Toledo International Inc.).

(Measurement of Specific Gravity)

The measurement was performed according to JIS Z 8807-1976. A 4 cm×8.5 cm adhesive layer strip (of arbitrary thickness) was cut from the polyester-based hot-melt adhesive and used as a sample for the specific gravity measurement. The sample was allowed to stand in an environment at a temperature of 23° C.±2° C. and a humidity of 50%±5% for 16 hours. The sample was measured for specific gravity using a specific gravity meter (manufactured by Sartorius AG).

(Measurement of Melt Flow Index (MI))

The melt flow index of the polyester-based hot-melt adhesive was measured according to ASTM-D-1238 under the conditions of 150° C. and 2.16 kg.

(Peel Test)

A 25-mm-wide, 200-mm-long, sample was cut from the prepared laminated polishing pad. The polishing layer and the support layer of the sample were pulled from each other at a pulling angle of 180° and a pulling rate of 300 mm/minute when it was observed how peeling occurred in the sample.

### Production Example 1

### Preparation of Polishing Layer

To a vessel were added 1,229 parts by weight of toluene diisocyanate (a mixture of 2,4-diisocyanate/2,6-diisocyanate=80/20), 272 parts by weight of 4,4′-dicyclohexylmethane diisocyanate, 1,901 parts by weight of polytetramethylene ether glycol with a number average molecular weight of 1,018, and 198 parts by weight of diethylene glycol, and allowed to react at 70° C. for 4 hours, so that an isocyanate-terminated prepolymer was obtained.

To a polymerization vessel were added 100 parts by weight of the prepolymer and 3 parts by weight of a silicone surfactant (SH-192 manufactured by Dow Corning Toray Co., Ltd.) and mixed. The mixture was adjusted to 80° C. and degassed under reduced pressure. Subsequently, the reaction system was vigorously stirred for about 4 minutes with a stirring blade at a rotational speed of 900 rpm so that air bubbles were incorporated into the reaction system. Thereto was added 26 parts by weight of MOCA (CUAMINE-MT, manufactured by IHARA CHEMICAL INDUSTRY CO., LTD.), whose temperature was adjusted to 120° C. in advance. The liquid mixture was stirred for about 1 minute and then poured into a rectangular pan-shaped open mold (casting vessel). At the point when the liquid mixture lost its fluidity, it was placed in an oven, and subjected to post curing at 100° C. for 16 hours, so that a polyurethane resin foam block was obtained.

While heated at about 80° C., the polyurethane resin foam block was sliced using a slicer (VGW-125 manufactured by AMITEC Corporation), so that a polyurethane resin foam sheet (50 μm in average cell diameter, 0.86 in specific gravity, and 52 degrees in hardness) was obtained. In a buffing machine (manufactured by AMITEC Corporation), the surface of the polyurethane resin foam sheet was then buffed with #120, #240, and #400 sandpaper sequentially, so that a polishing layer (2 mm in thickness, 550 mm in width, 1,200 mm in length) with an adjusted thickness accuracy was obtained.

### Production Example 2

### Preparation of Polishing Layer

A polishing layer (2 mm in thickness, 200 mm in minimum width, 550 mm in maximum width, 1,200 mm in length) was prepared using the same process as in Production Example 1, except that an octagonal pan-shaped open mold was used instead of the rectangular pan-shaped open mold.

### Production Example 3

### Preparation of Polishing Layer

A polishing layer (2 mm in thickness, 150 mm in minimum width, 550 mm in maximum width, 1,200 mm in length) was prepared using the same process as in Production Example 1, except that an octagonal pan-shaped open mold was used instead of the rectangular pan-shaped open mold.

### Example 1

An adhesive layer (50 μm in thickness) was formed on a support layer made of a urethane foam (NIPPALAY EXT manufactured by NHK Spring Co., Ltd, 550 mm in width) while the support layer was conveyed. The adhesive layer was made of a polyester-based hot-melt adhesive (142° C. in melting point, 1.22 in specific gravity, 21 g/10 min in melt flow index) containing 100 parts by weight of a crystalline polyester resin (VYLON GM 420 manufactured by TOYOBO CO., LTD.) and 5 parts by weight of an o-cresol novolac type epoxy resin (EOCN 4400 manufactured by Nippon Kayaku Co., Ltd.) having at least two glycidyl groups per molecule. The surface of the adhesive layer was heated to 150° C. using an infrared heater so that the adhesive layer was molten. Subsequently, using a laminator, the polishing layer prepared in Production Example 1 was placed on the molten adhesive layer to forma laminate. In this process, TD1/TD2 was 550 mm/550 mm=1. Subsequently, the laminate was allowed to pass between a pair of lamination rolls in such a way that the front end of the polishing layer was parallel to the rotating shafts of the lamination rolls, so that the polishing layer and the support layer were bonded with the adhesive layer to form a laminated polishing sheet. The prepared laminated polishing sheet had no wrinkles, and no air was trapped in the sheet. Subsequently, using a laminator, a pressure-sensitive double-sided tape (442JA manufactured by 3M Company) was bonded to the support layer of the laminated polishing sheet. The resulting laminated polishing sheet was cut into a diameter of 508 mm. Subsequently, concentric circular grooves with a width 0.25 mm, a pitch of 1.5 mm, and a depth of 0.6 mm were formed on the surface of the polishing layer using a grooving machine (manufactured by Techno Corporation), so that a laminated polishing pad was obtained.

Using the prepared laminated polishing pad, semiconductor wafers were successfully polished in a uniform fashion. In the peel test performed as described above, the mode of peeling in the sample was material failure.

### Example 2

A laminated polishing sheet was prepared using the same process as in Example 1. Subsequently, concentric circular grooves with a width 0.25 mm, a pitch of 1.5 mm, and a depth of 0.6 mm were formed on the surface of the polishing layer using a grooving machine (manufactured by Techno Corporation). The laminated polishing sheet was then cut into a diameter of 508 mm. The prepared laminated polishing sheet had no wrinkles, and no air was trapped in the sheet. Subsequently, using a laminator, a pressure-sensitive double-sided tape (442JA manufactured by 3M Company) was bonded to the support layer of the laminated polishing sheet, so that a laminated polishing pad was obtained.

Using the prepared laminated polishing pad, semiconductor wafers were successfully polished in a uniform fashion. In the peel test performed as described above, the mode of peeling in the sample was material failure.

### Example 3

A laminated polishing pad was prepared (see FIG. 4) using the same process as in Example 2, except that the polishing layer prepared in Production Example 2 was used instead of that prepared in Production Example 1. The minimum TD1/TD2 value was 0.36 (200 mm/550 mm). The prepared laminated polishing sheet had no wrinkles, and no air was trapped in the sheet.

Using the prepared laminated polishing pad, semiconductor wafers were successfully polished in a uniform fashion. In the peel test performed as described above, the mode of peeling in the sample was material failure.

### Example 4

An adhesive layer (50 μm in thickness) was formed on a support layer made of a urethane foam (NIPPALAY EXT manufactured by NHK Spring Co., Ltd, 550 mm in width) while the support layer was conveyed. The adhesive layer was made of a polyester-based hot-melt adhesive (140° C. in melting point, 1.24 in specific gravity, 26 g/10 min in melt flow index) containing 100 parts by weight of a crystalline polyester resin (VYLON GM 420 manufactured by TOYOBO CO., LTD.) and 2 parts by weight of an o-cresol novolac type epoxy resin (EOCN 4400 manufactured by Nippon Kayaku Co., Ltd.) having at least two glycidyl groups per molecule. The surface of the adhesive layer was heated to 150° C. using an infrared heater so that the adhesive layer was molten. Subsequently, a laminated polishing pad was prepared using the same process as in Example 1.

Using the prepared laminated polishing pad, semiconductor wafers were successfully polished in a uniform fashion. In the peel test performed as described above, the mode of peeling in the sample was material failure.

### Example 5

An adhesive layer (50 μm in thickness) was formed on a support layer made of a urethane foam (NIPPALAY EXT manufactured by NHK Spring Co., Ltd, 550 mm in width) while the support layer was conveyed. The adhesive layer was made of a polyester-based hot-melt adhesive (145° C. in melting point, 1.19 in specific gravity, 16 g/10 min in melt flow index) containing 100 parts by weight of a crystalline polyester resin (VYLON GM 420 manufactured by TOYOBO CO., LTD.) and 10 parts by weight of an o-cresol novolac type epoxy resin (EOCN 4400 manufactured by Nippon Kayaku Co., Ltd.) having at least two glycidyl groups per molecule. The surface of the adhesive layer was heated to 150° C. using an infrared heater so that the adhesive layer was molten. Subsequently, a laminated polishing pad was prepared using the same process as in Example 1.

Using the prepared laminated polishing pad, semiconductor wafers were successfully polished in a uniform fashion. In the peel test performed as described above, the mode of peeling in the sample was material failure.

### Comparative Example 1

The polishing layer prepared in Production Example 1 was cut into a diameter of 508 mm.

An adhesive layer (50 μm in thickness) used in Example 1 was formed on a support layer made of a urethane foam (NIPPALAY EXT manufactured by NHK Spring Co., Ltd, 550 mm in width) while the support layer was conveyed. The surface of the adhesive layer was heated to 150° C. using an infrared heater so that the adhesive layer was molten. Subsequently, using a laminator, the 508-mm-diameter polishing layer was placed on the molten adhesive layer to form a laminate. Subsequently, the laminate was allowed to pass between a pair of lamination rolls, so that the polishing layer and the support layer were bonded with the adhesive layer to form a laminated polishing sheet. The prepared laminated polishing sheet had wrinkles, and air was trapped in the sheet. Subsequently, using a laminator, a pressure-sensitive double-sided tape (442JA manufactured by 3M Company) was bonded to the support layer of the laminated polishing sheet. The resulting laminated polishing sheet was cut into a diameter of 508 mm. Subsequently, concentric circular grooves with a width 0.25 mm, a pitch of 1.5 mm, and a depth of 0.6 mm were formed on the surface of the polishing layer using a grooving machine (manufactured by Techno Corporation), so that a laminated polishing pad was obtained.

Semiconductor wafers were polished with the prepared laminated polishing pad. As a result, unevenness occurred in the polishing of the semiconductor wafers. In the peel test performed as described above, the mode of peeling in the sample was interfacial delamination. The wrinkles and the trapped air would be the cause of polishing unevenness and interfacial delamination.

### Comparative Example 2

A laminated polishing pad was prepared (see FIG. 4) using the same process as in Example 1, except that the polishing layer prepared in Production Example 3 was used instead of that prepared in Production Example 1. The minimum TD1/TD2 value was 0.27 (150 mm/550 mm). The prepared laminated polishing sheet had wrinkles, and air was trapped in the sheet.

Semiconductor wafers were polished with the prepared laminated polishing pad. As a result, unevenness occurred in the polishing of the semiconductor wafers. In the peel test performed as described above, the mode of peeling in the sample was interfacial delamination. The wrinkles and the trapped air would be the cause of polishing unevenness and interfacial delamination.

### INDUSTRIAL APPLICABILITY

A laminated polishing pad of the invention is capable of performing planarization materials requiring a high surface planarity such as optical materials including a lens and a reflective mirror, a silicon wafer, a glass substrate or an aluminum substrate for a hard disk and a product of general metal polishing with stability and a high polishing efficiency. A laminated polishing pad of the invention is preferably employed, especially, in a planarization step of a silicon wafer or a device on which an oxide layer or a metal layer has been formed prior to further stacking an oxide layer or a metal layer thereon.

### DESCRIPTION OF REFERENCE SIGNS

In the drawings, reference numeral 1 represents a laminated polishing pad, 2 a polishing platen, 3 a polishing agent (slurry), 4 an object to be polished (semiconductor wafer), 5 a support (polishing head), 6 and 7 each a rotating shaft, 8 a support layer, 9 a polishing layer, 10 a lamination roll.

1. A method for manufacturing a laminated polishing pad, comprising the steps of: preparing a laminate comprising a polishing layer, a support layer, and a hot-melt adhesive member placed between the polishing layer and the support layer; and allowing the laminate to pass between a pair of lamination rolls so that the polishing layer and the support layer are bonded with the hot-melt adhesive member to form a laminated polishing sheet, wherein
in the laminate, the ratio TD1/TD2 is constantly adjusted to 0.3 or more, wherein TD1 is the transverse direction (TD) length of the polishing layer, and TD2 is the transverse direction (TD) length of the support layer.

2. The method according to claim 1, further comprising the step of cutting the laminated polishing sheet into a circular shape.

3. The method according to claim 2, further comprising the step of grooving a surface of the laminated polishing sheet.

4. The method according to claim 1, wherein the hot-melt adhesive member is an adhesive layer comprising a polyester-based hot-melt adhesive or a double-sided adhesive tape comprising a backing and the adhesive layers provided on both sides of the baking and each comprising a polyester-based hot-melt adhesive, wherein the polyester-based hot-melt adhesive comprises 100 parts by weight of a polyester resin as a base polymer and 2 to 10 parts by weight of an epoxy resin having two or more glycidyl groups per molecule.

5. The method according to claim 4, wherein the polyester resin is a crystalline polyester resin.

6. A laminated polishing pad obtained by the method claim 1.

7. A method for producing a semiconductor device, comprising the step of polishing a surface of a semiconductor wafer with the laminated polishing pad according to claim 6.

8. The method according to claim 2, further comprising the step of grooving a surface of the laminated polishing sheet.

9. The method according to claim 2, wherein the hot-melt adhesive member is an adhesive layer comprising a polyester-based hot-melt adhesive or a double-sided adhesive tape comprising a backing and the adhesive layers provided on both sides of the baking and each comprising a polyester-based hot-melt adhesive, wherein the polyester-based hot-melt adhesive comprises 100 parts by weight of a polyester resin as a base polymer and 2 to 10 parts by weight of an epoxy resin having two or more glycidyl groups per molecule.

10. The method according to claim 3, wherein the hot-melt adhesive member is an adhesive layer comprising a polyester-based hot-melt adhesive or a double-sided adhesive tape comprising a backing and the adhesive layers provided on both sides of the baking and each comprising a polyester-based hot-melt adhesive, wherein the polyester-based hot-melt adhesive comprises 100 parts by weight of a polyester resin as a base polymer and 2 to 10 parts by weight of an epoxy resin having two or more glycidyl groups per molecule.

11. The method according to claim 9, wherein the polyester resin is a crystalline polyester resin.

12. The method according to claim 10, wherein the polyester resin is a crystalline polyester resin.

13. A laminated polishing pad obtained by the method claim 2.

14. A laminated polishing pad obtained by the method claim 3.

15. A laminated polishing pad obtained by the method claim 4.

16. A laminated polishing pad obtained by the method claim 5.
